(19) United States
(12) Patent Application Publication
(10) Pub. No.: US 2026/0165326 A1
(43) Pub. Date: Jun. 18, 2026

(54) AGRICULTURAL FORMULATIONS AND USES THEREOF

(71) Applicant: Valent U.S.A. LLC, San Ramon, CA (US)

(72) Inventors: Toshiya Ogawa, San Ramon, CA (US); Ke Zhou, San Ramon, CA (US)

(21) Appl. No.: 19/415,941

(22) Filed: Dec. 11, 2025

Related U.S. Application Data
(60) Provisional application No. 63/733,005, filed on Dec. 12, 2024.

(51) Int. Cl. A01N 43/78; A01N 25/04; A01N 37/26; A01N 43/56; A01P 3/00

(52) U.S. Cl. CPC A01N 43/78; A01N 25/04; A01N 37/26; A01N 43/56; A01P 3/00

(57) ABSTRACT

The present invention is generally related to an agricultural formulation comprising metalaxyl and inpyrfluxam but not comprising propylene glycol. The present invention is further related to an agricultural formulation inpyrfluxam, metalaxyl, and one or more excipients selected from the group consisting of a poly(ethylene oxide)-poly(propylene oxide)-poly(ethylene oxide) block copolymer, modified styrene acrylic copolymer, an acrylic copolymer aqueous emulsion, and a hydrophilic fumed silica. The present invention is further related to methods of protecting plants and/or controlling pests comprising applying a formulation of the present invention to a plant, a pest or an area where a plant will grow.

### FIELD OF THE INVENTION

The present invention is generally related to an agricultural formulation comprising metalaxyl and inpyrfluxam but not comprising propylene glycol. The present invention is further related to an agricultural formulation comprising inpyrfluxam, metalaxyl, and one or more excipients selected from the group consisting of a poly(ethylene oxide)-poly(propylene oxide)-poly(ethylene oxide) block copolymer, modified styrene acrylic copolymer, an acrylic copolymer aqueous emulsion, and a hydrophilic fumed silica. The present invention is further related to methods of protecting plants and/or controlling pests comprising applying a formulation of the present invention to a plant, a pest or an area where a plant will grow.

### BACKGROUND OF THE INVENTION

Fungal infections are a major concern for crop growers. Fungi can be present on the seed surface prior to planting, they can be soil-borne, or they can be introduced into the growing environment by mobile pests or equipment. Fungi infect seeds and seedlings and destroy plant cells and tissues and thereby prevent seed germination or cause poor development or death of seedlings. Aphanomyces, Fusarium, Helminthosporium, Pythium, and Rhizoctonia are all known to cause infection and death of plants. These organisms cause seed rot, damping-off, seed blight, and root rot. Even diseases that affect adult plants can be controlled by pesticidal seed treatments (e.g., smuts caused by Ustilago, Tilletia, and Urocystis).

Metalaxyl is a widely used fungicide for controlling diseases among crops. Metalaxyl is the active ingredient in the seed treatment marketed as Sebring® 318 FS (Sebring is a registered trademark of and available from Nufarm Americas Inc) and Allegiance® FL. However, metalaxyl presents many formulations challenges including its low melting point (63-72° C.) and partial water solubility (8,400 parts per million). Liquid formulations of metalaxyl often form large crystals upon storage. Further, due to its low melting point and chemistry, formulating metalaxyl with other low-melting point pesticides is highly problematic. U.S. Pat. No. 11,064,695B2 refers to this low melting point issue with metalaxyl and demonstrates a formulation containing propylene glycol capable of overcoming the co-melting of metalaxyl and another low melting point active (i.e. inpyrfluxam).

There remains a need in the art for additional physically and chemically stable formulations containing metalaxyl and other low-melting point pesticides useful for seed treatment that provides improved protection against fungal pests.

### SUMMARY OF THE INVENTION

The present invention is directed to an agricultural formulation comprising inpyrfluxam and metalaxyl, wherein the formulation does not comprise propylene glycol.

The present invention is further directed to an agricultural formulation comprising formulation comprising inpyrfluxam, metalaxyl, and one or more excipients selected from the group consisting a poly(ethylene oxide)-poly(propylene oxide)-poly(ethylene oxide) block copolymer, modified styrene acrylic copolymer, an acrylic copolymer aqueous emulsion, and a hydrophilic fumed silica.

The present invention is further directed to a method of protecting plants comprising treating plant propagation material with a fungicidally effective amount of an agricultural formulation of the present invention.

The present invention is further directed to a method for controlling or preventing pest damage of plants comprising applying to the plant propagation material an effective amount of an agricultural formulation of the present invention.

### DETAILED DESCRIPTION OF THE INVENTION

The Applicant has discovered a stable agricultural formulation comprising metalaxyl and inpyrfluxam that does not require propylene glycol. A stable agricultural formulation comprising metalaxyl and inpyrfluxam is unexpected because of the co-melting that occurs between metalaxyl and other actives. As previously mentioned, stable formulations containing metalaxyl and active ingredients that co-melt with metalaxyl are difficult to obtain because metalaxyl and or the co-melting actives forms undesirable crystals. Applicants unexpectedly found that formulations of the present invention provide a superior solution to this known problem in the art.

In one embodiment, the present invention is directed to an agricultural formulation comprising metalaxyl and inpyrfluxam, wherein the formulation does not comprise propylene glycol.

In another embodiment, the present invention is directed to an agricultural formulation comprising inpyrfluxam, metalaxyl, and one or more excipients selected from the group consisting of a poly(ethylene oxide)-poly(propylene oxide)-poly(ethylene oxide) block copolymer, modified styrene acrylic copolymer, an acrylic copolymer aqueous emulsion, and a hydrophilic fumed silica.

In another preferred embodiment, the agricultural formulation further comprises one or more excipients selected from the group consisting of glycerin, a xanthan gum, a sodium salt of naphthalene sulfonate condensate, a silicone emulsion, magnesium aluminum silicate and 1,2-benzisothiazolin-3-one.

Inpyrfluxam may be present in formulations of the present invention at a concentration from about 0.1% to about 15% w/w, preferably from about 1% to about 10% w/w, even more preferably from about 2% to about 5% w/w, yet even more preferably from about 3% to about 4% w/w.

Metalaxyl may be present in formulations of the present invention at a concentration from about 0.1% to about 15% w/w, more preferably from about 1% to about 10% w/w, even more preferably from about 1% to about 5% w/w yet even more preferably from about 2% to about 3% w/w.

In a preferred embodiment, formulations of the present invention further comprise ethaboxam. Ethaboxam may be present in formulations of the present invention at a concentration from about 0.1% to about 15% w/w, more preferably from about 1% to about 10% w/w, even more preferably from about 4% to about 6% w/w, yet even more preferably from about 5% to about 6% w/w.

Poly(ethylene-oxide)-poly(propylene oxide)-ploy(ethylene oxide) block copolymer may be present in formulations of the present invention at a concentration from about 0.1% to about 10% w/w, preferably from about 1% to about 10% w/w, more preferably from about 5% to about 6% w/w.

Modified styrene acrylic copolymer may be present in formulations of the present invention at a concentration from about 0.5% to about 10% w/w, preferably from about 1% to about 5% w/w, more preferably from about 1% to about 3% w/w.

An acrylic copolymer aqueous emulsion may be present in formulations of the present invention at a concentration from about 1% to about 30% w/w, preferably from about 3% to about 20% w/w, more preferably from about 9% to about 11% w/w.

A hydrophobic fumed silica may be present in formulations of the present invention at a concentration from about 0.01% to about 5% w/w, preferably from about 0.01% to about 2% w/w, more preferably from about 0.1% to about 1.5% w/w.

Glycerin may be present in formulations of the present invention at a concentration from about 1% to about 40% w/w, preferably from about 1% to about 20% w/w, even more preferably from about 1% to about 10% w/w, yet even more preferably from about 7% to about 9% w/w.

Xanthan gum may be present in formulations of the present invention at a concentration from about 0.01% to about 5% w/w, preferably from about 0.1% to about 1% w/w, even more preferably from about 0.3% to about 0.5% w/w.

A sodium salt of naphthalene sulfonate condensate may be present in formulations of the present invention at a concentration from about 1% to about 15% w/w, preferably from about 1% to about 10% w/w, even more preferably from about 3% to about 5% w/w.

A grafted copolymer may be present in formulations of the present invention at a concentration from about 0.5% to about 15% w/w, preferably from about 1% to about 5% w/w, even more preferably from about 1% to about 3% w/w.

Grafted modified styrene-maleic anhydride copolymer monomethyl ether may be present in formulations of the present invention at a concentration from about 0.5% to about 15% w/w, preferably from about 1% to about 5% w/w, even more preferably from about 1% to about 3% w/w.

A silicone emulsion may be present in formulations of the present invention at a concentration from about 0.001% to about 1% w/w, preferably from about 0.01% to about 0.5% w/w, even more preferably from about 0.04% to about 0.06% w/w.

Magnesium aluminum silicate may be present in formulations of the present invention at a concentration from about 0.01% to about 5% w/w, preferably from about 0.1% to about 2% w/w, even more preferably from about 0.1% to about 0.6% w/w.

1,2-benzisothiazolin-3-one may be present in formulations of the present invention at a concentration from about 0.01% to about 5% w/w, preferably from about 0.1% to about 2% w/w, even more preferably from about 0.4% to about 0.5% w/w, and most preferably at about 0.45% w/w.

Formulations of the present invention may comprise an additional excipient selected from the group consisting of a grafted copolymer, grafted modified styrene-maleic anhydride copolymer monomethyl ether and a mixture thereof. Sources of grafted copolymers include Agnique® CP 72CL. Agnique is a registered trademark and available from Cognis IP management. Agnique® CP 72CL is a grafted copolymer based on a vinyl acetate. Sources of grafted modified styrene-maleic anhydride copolymer monomethyl ether include Tersperse® 2612. Tersperse is a registered trademark of and available from Huntsman Petrochemical Corporation.

In a preferred embodiment, the present invention is directed to a formulation comprising from about 0.1% to about 15% w/w inpyrfluxam, from about 0.1% to about 15% w/w metalaxyl, from about 0.1% to about 10% w/w of a poly(ethylene oxide)-poly(propylene oxide)-poly(ethylene oxide) block copolymer, from about 0.5% to about 10%/ww modified styrene acrylic copolymer, from about 1% to about 30% w/w of an acrylic copolymer aqueous emulsion, and from about 0.01% to about 5% w/w of a hydrophilic fumed silica.

In another preferred embodiment, the present invention is directed to a formulation comprising from about 1% to about 10% w/w inpyrfluxam, from about 1% to about 10% w/w metalaxyl, from about 1% to about 10% w/w of a poly(ethylene-oxided)-poly(propylene oxide)-ploy(ethylene oxide) block copolymer, from about 1% to about 5% w/w modified styrene acrylic copolymer, from about 3% to about 20% w/w of an acrylic copolymer aqueous emulsion, and from about 0.01% to about 1% w/w of a hydrophobic fumed silica.

In another preferred embodiment, the present invention is directed to a formulation comprising from about 3% to about 4% w/w inpyrfluxam, from about 2% to about 3% w/w metalaxyl, from about 5% to about 6% w/w of a poly(ethylene-oxided)-poly(propylene oxide)-ploy(ethylene oxide) block copolymer, from about 1% to about 3% w/w modified styrene acrylic copolymer, from about 9% to about 11% w/w of an acrylic copolymer aqueous emulsion, and from about 0.4% to about 0.6% w/w of a hydrophobic fumed silica.

In another embodiment, the present invention is further directed to a method of protecting plants comprising treating plant propagation material with a fungicidally effective amount of an agricultural formulation of the present invention.

In another embodiment, the present invention is further directed to a method for controlling or preventing pest damage of plants comprising applying to the plant propagation material an effective amount of an agricultural formulation of the present invention.

As used herein, “plant propagation material” refers to seeds, bulbs, rhizomes and tubers

In a preferred embodiment, the plant propagation material is a seed. In a more preferred embodiment, the formulations of the present invention are applied to the seeds before they are planted.

In another preferred embodiment the plant that is treated is a crop plant. In a more preferred embodiment, the crop plant is selected from the group consisting of corn, soybeans, beans, peas, lentils, flax, wheat, rice, canola, sorghum, barley, oats, rye, millet and sugar beets.

The phrase “effective amount” of the formulation means a sufficient amount of the formulation to provide the desired effect. In general, the formulation is employed in amounts that do not inhibit germination of the seeds (or cause phytotoxic damage to the seeds) while providing adequate pest control. Pest control can mean reducing pest damage to the plant, reducing the amount of pests on the plant or in its immediate environment, or preventing the pests from reproducing, among other things. The amount of the formulation may vary depending on specific crops and other factors. It is well within the ordinary skill in the art to determine the necessary amount of the formulation

As used herein, “pest” refers to pathogens and parasites that negatively affect the host plants by colonizing, attacking, irritating, or feeding upon them, or competing for nutrients with the host. A pest may be, for example, an undesirable bacterium, fungus including fungal pathogens, or insect.

Fungal pathogens include but are not limited to Rhizoctonia, Fusarium, Pythium Phytophthora, Phomopsis, and seed decay fungi including Aspergillus, Penicillium, Alternaria, Rhizopus, and Basidiomycete bunt and smut fungi.

As used herein, “plant” and “plants” refer to wild type and genetically modified members of the plant kingdom, including higher (vascular) plants and lower (non-vascular) plants.

As used herein, “crop plants” refers to cereal, legumes, forage crops, stem and leaf crops, tuber, bulb and root crops, fruit and seed vegetables, fruit and nut crops, beverage crops, oil, fat and wax crops, spices, perfumes and flavorings, and ornamentals, forest and fiber crops.

The formulations of the present invention may be applied simultaneous or sequentially to the areas in need of treatment.

The formulations of the present invention can be applied to any environment in need of pest control. The environment in need of pest control may include any area that is desired to have a reduced number of pests or to be free of pests. For example, the pesticide can be applied to areas where crop plants are grown.

As used herein, “controlling or preventing pest damage of plants” refers to maintaining the population of the target pest at a rate per plant such that the plant is viable and produces an agriculturally useful product.

As used herein, all numerical values relating to amounts, weights, and the like, that are defined as “about” each particular value is plus or minus 10%. For example, the phrase “about 10% w/w” is to be understood as “9% w/w to 11% w/w.” Therefore, amounts within 10% of the claimed value are encompassed by the scope of the claims.

As used herein “% w/w” and “percent w/w” refer to the percent weight of the total formulation.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

### EXAMPLES

### Example 1—Surfactant Screening

TABLE 1

| % w/w | Fomulation A |
|---|---|
| Ethaboxam | 11.5 |
| Inpyrfluxam | 7.7 |
| Metalaxyl | 6.1 |
| Surfactant | See Table 2 |

TABLE 2

| | 54° C. 2 weeks (Bottom | | F/T 2 weeks |
|---|---|---|---|
| Surfactant | Clear Time/Sprayability) | | Sprayability |
| Untreated Control | >10 | min | Does not |
| | | | move |
| 3% Pluronic ® P-105 | >10 | min | 0.14% |
| 4% Pluronic P-105 | >10 | min | 0.032% |
| 3% Morwet ® D-425 | >10 | min | 0.0095% |
| 5% Morwet ® D-425 | >10 | min | 0.0076% |
| 3% Pluronic ® P-105 + | >10 | min | 0.0036% |
| 3% Morwet ® D-425 | | | |
| 3% Step-flow ® T6 | >10 | min | 0.0057% |
| 5% Step-flow ® T6 | ~7 min/0.054% | | <0.01% |
| 3% Atlox ® 4917 | ~7 | min | 0.077% |
| 5% Atlox ® 4917 | 6 s/0.068% | | 0.026% |
| 5% Darvan ® 7-N | 3 | s | 0.13% |
| 5% Darvan ® 811 | >10 | min | Not tested |
| 10% Michem Lube ® 156PFP | >10 | min | Not tested |
| 10% Esentia NA-STK-COAT | 1 min 30 s/0.0041% | | 0.0028% |
| 10% Selvol ® 09-523 | >10 | min | Not tested |
| 5% Tersperse ® 2500 | Fused Chunks/0.035% | | 0.0019% |
| 5% Atlox ® 4913 | Fused Chunks/0.0050% | | 0.0033% |
| 5% Step-flow ® 3000 | Fused Chunks/0.0036% | | 0.0113% |
| 5% Step-flow ® 4000 | Fused Chunks/0.0038% | | 0.0023% |
| 5% Agrilan ® 755 | Fused Chunks/0.0049% | | 0.0027% |
| 5% Reax ® 88A | Gelled | | — |
| 5% Reax ® 88B | Gelled | | — |
| 5% Kraftsperse ® 25M | Gelled | | — |
| 5% Kraftsperse ® DW-8 | >10 | min | — |

| | | |
|---|---|---|
| 5% Greensperse ® S-9 | Gelled | — |

Ethaboxam TG was used as the source of ethaboxam and is available from Sumitomo Chemical Company.

Metalaxyl TG was used as the source of metalaxyl and is available from Nufarm Americas, Inc.

Inpyrfluxam TG was used as the source of Inpyrfluxam and is available from Sumitomo Chemical Company.

Pluronic® P-105 is a poly(ethylene oxide)-poly(propylene oxide)-poly(ethylene oxide) block copolymer (Pluronic is a registered trademark of and available from BASF Corporation). Pluronic® P105 has an average molecular weight of 6500 and a hydrophile weight percentage of 50%.

Morwet® D-425 is a sodium salt of naphthalene sulfonate condensate (Morwet is a registered trademark of and available from Akzo Nobel Surface Chemistry LLC).

Step-flow® T6 was used as a source of high performance polymeric dispersant (Step-flow is a registered trademark of and available from Stepan Company).

Tersperse® 2500 was used as the source of 35% grafted copolymer (Tersperse is a registered trademark of and available from Huntsman Petrochemical Corporation).

Atlox® 4917 was used as the source of modified styrene acrylic copolymer (Atlox is a registered trademark of and available from Croda Inc.).

Darvan® 7-N was used as a sodium polymethacrylate (Darvan is a registered trademark of and available from Vanderbilt Minerals LLC).

Darvan® 811 was used as a sodium Polymethacrylate (Darvan is a registered trademark of and available from Vanderbilt Minerals LLC).

Michem Lube® is a carnauba wax dispersion (Michem is a registered trademark of and available from Michelman Inc).

Esentia NA-STK-COAT was used as a source of an acrylic copolymer aqueous emulsion.

Emulson AG COAT US was used a source of an acrylic copolymer aqueous emulsion. Esentia and Emulson are available from Lamberti SPA.

Selvol® 09-523 was used as a 9% polyvinyl alcohol solution (Selvol is a registered trademark of and available form Sekisui Special Chemicals Amer).

Atlox® 4913 is a 35% grafted copolymer (Atlox is a registered trademark of and available form Croda Americas LLC).

Step-flow® 3000 is a polymethyl methacrylate-polyethylene glycol grafted copolymer having a viscosity of 490 centipoise at 25° C. (Step-flow is a registered trademark of and available form Stepan Company).

Step-flow® 4000 is a polymethyl methacrylate-polyethylene glycol grafted copolymer having a viscosity of 80 centipoise at 25° C. (Step-flow is a registered trademark of and available form Stepan Company).

Agrilan® 755 is a soft anionic polymer based on a methyl methacrylate backbone grafted with PEG (Agrilan is a registered trademark of and available from Nouryon).

Reax® 88A is a sodium lignosulfonate (Reax is a registered trademark of and available from Huntsman Petrochemical Corporation).

Reax® 88B is a sodium lignosulfonate (Reax is a registered trademark of and available from Huntsman Petrochemical Corporation).

Kraftsperse® 25M is a sodium lignosulfonate (Kraftsperse is a registered trademark of and available from Ingevity).

Kraftsperse® DW-8 is a lignosulfonate (Kraftsperse is a registered trademark of and available from Ingevity).

Greensperse® S-9 is a lignosulfonate (Greensperse is a registered trademark of and available from Borregard).

### Methods

Formulation A of Table 1, above, was formulated without a surfactant or with one of each of the 24 surfactants/surfactant combinations from Table 2, above. These 25 formulations were subjected to 54° C. for 2 weeks and also 2 weeks of freeze/thaw (“F/T”) cycles. Following storage at the accelerated storage conditions, the 25 formulations were measured for bottom clear time and sprayability. Results of this experiment are shown in Table 2, above.

Bottom clear time is the time until the composition flows away from the container bottom when 62.5 milliliters of the composition is placed in a 125-milliliter plastic jar and placed on its side. A high bottom clear time indicates poor flowability stability.

### Sprayability

Sprayability is based on the following test procedure and calculation. A 100-mesh (150 micrometer) sieve is weighed and the weight is recorded as the tare weight (“W0”). The sieve is then placed over a wide mouth jar.

50 grams of a composition (“W”) is weighed and added to 600 milliliters of tap water, the composition was then stirred for approximately two minutes to create a dispersion.

The entire dispersion was poured through the sieve followed by rinsing. Rinsing was done using tap water at a flow rate at about 1.5 liters per minute for one minute. The sieve with the residue was then placed in a drying oven and dried to create the dry sieve with the residue (“W1”). Percent sprayability was then calculated with the following equation: (W1−W0)/W*100.

A large percent sprayability indicates poor formulation stability leading to nozzle clogging during field application. Formulation should have a sprayability no more than 0.05% w/w under all conditions.

### Results

As can be seen in Table 2, above, the addition of Morwet® D-425, Atlox® 4917, Step-flow® T6, and Esentia NA-STK-COAT provided sufficient stability.

### Example 2—Surfactant Combination Screening

### Methods

Formulation A of Table 1, above, was formulated with each of the 10 surfactant combinations from Table 3, below. These 10 formulations were subjected to 54° C. for 2 weeks and also 2 weeks of freeze/thaw cycles. Following storage at the accelerated storage conditions, the 10 formulations were measured for bottom clear time and sprayability. Results of this experiment are shown in in Table 3, below.

TABLE 3

| Surfactant | 54° C. 2 weeks | F/T 2 weeks |
|---|---|---|
| Combinations | (Bottom/Sprayability) | Sprayability |
| 3% Morwet ® D-425 + | Gelled | — |
| 3% Atlox ® 4917 | | |
| 3% Morwet ® D-425 + | Gelled | — |
| 5% Atlox ® 4917 | | |
| 3% Morwet ® D-425 + | Gelled | — |
| 3% Darvan ® 7-N | | |
| 3% Morwet ® D-425 + | Gelled | — |
| 5% Darvan ® 7-N | | |
| 3% Morwet ® D-425 + | ~3 min/0.0224% | 0.0007% |
| 5% Step-flow ® T6 | | |
| 5% Morwet ® D-425 + | Gelled | — |
| Atlox ® 4917 | | |
| 5% Morwet ® D-425 + | Gelled | — |
| Darvan ® 7-N | | |
| 5% Morwet ® D-425 + | ~9 min/0.0040% | 0.007% |
| Step-flow ® T6 | | |
| 5% Morwet ® D-425 + | 30 s/0.0510% | 0.006% |
| 3% Pluronic ® L64 | | |
| 5% Morwet ® D-425 + | 6 s/0.0021% | 0.0013% |
| 3% Pluronic ® L92 | | |
| 5% Morwet ® D-425 + | Gelled | Gelled |
| 10% Esentia NA- | | |
| STK-COAT | | |
| 5% Morwet ® D-425 + | Gelled | Gelled |
| 10% Agrimer SCP | | |
| Polymer | | |
| 5% Morwet ® D-425 + | Gelled | Gelled |
| 10% Agrimer SCP | | |
| 2 Polymer | | |
| 5% Morwet ® D-425 + | Gelled | Gelled |
| 10% Michelman | | |
| NYS 2101 | | |
| 5% Morwet ® D-425 + | Gelled | Gelled |
| 10% Michelman | | |
| NYS 2104 | | |
| 5% Morwet ® D-425 + | Gelled | Gelled |
| 10% Michelman | | |
| 181186CX | | |
| 5% Morwet ® D-425 + | Gelled | Gelled |
| Dur-O-Set ® E-200 | | |
| 5% Morwet ® D-425 + | Gelled | Gelled |
| 5% Step-flow ® T6 | | |
| 5% Morwet ® D-425 + | >10 min | 0.14 |
| 5% Esentia NA- | | |
| STK-COAT + | | |
| 5% Step-flow ® T6 | | |

Pluronic® L64 is a poly(ethylene oxide)-poly(propylene oxide)-poly(ethylene oxide) block copolymer available from BASF Corporation. Pluronic® L64 has an average molecular weight of 2900.

Pluronic® L92 is a poly(ethylene oxide)-poly(propylene oxide)-poly(ethylene oxide) block copolymer available from BASF Corporation, Pluronic® L92 has an average molecular weight of 3650 and a hydrophile weight percentage of 200%.

Dur-O-Set® E-200 was used as the source of vinyl acetate ethylene copolymer emulsion (Dur-O-Set is a registered trademark of and available from Celanese International Corporation).

### Results

As exhibited in Table 3, to avoid gelling, formulations with combinations of Morwet® D-45 and Step-flow® T6, Pluronic® L64, Pluronic® L92 and Esentia NA-ST-COAT provided sufficient stability.

### Example 3—Formulations Stability

### Methods

The formulations in Table 4, below, were prepared and subjected to 40° C. for 4 weeks, 50° C. for 4 weeks and also 2 weeks of freeze/thaw (“F/T”) cycles. Following storage at the accelerated storage conditions, the 4 formulations were measured for bottom clear time and sprayability. Results of this experiment are shown in Tables 5 and 6, below.

TABLE 4

| % w/w | 2 | 3 | 4 | 5 |
|---|---|---|---|---|
| Ethaboxam | 10.457 | 10.457 | 10.457 | 10.457 |
| Inpyrfluxam | 6.972 | 6.972 | 6.972 | 6.972 |
| Metalaxyl | 5.577 | 5.577 | 5.577 | 5.577 |
| Pluronic ® L92 | 5.257 | 5.257 | 5.257 | 7.257 |
| Morwet ® D-425 | 3.029 | 3.029 | 3.029 | 3.029 |
| Step-flow ® T6 | — | 2.000 | — | — |
| Atlox ® 4917 | — | — | 2.000 | — |
| Xiameter ® AFE-0100 | 0.051 | 0.051 | 0.051 | 0.051 |
| Kelzan ® CC | 0.197 | 0.197 | 0.197 | 0.197 |
| Proxel ® GXL | 0.297 | 0.297 | 0.297 | 0.297 |
| Glycerin | 8.000 | 8.000 | 8.000 | 8.000 |
| Emulson AG COAT US | 10.000 | 10.000 | 10.000 | 10.000 |
| Water | Q.S. | Q.S. | Q.S. | Q.S. |

TABLE 5

| Bottom clear time | 2 | 3 | 4 | 5 |
|---|---|---|---|---|
| 2 w F/T | <1″ | <1″ | <1″ | 1″ |
| 4 w 40° C. | 3″ w/film | 2″ | 1″ w/ring | <1″ |
| 4 w 50° C. | Bottom gel | gel | 7% Settling* | gel |

*required shakings to redisperse

TABLE 6

| Sprayability, | | | | |
|---|---|---|---|---|
| 100 mesh, % | 2 | 3 | 4 | 5 |
| 2 w F/T | 0.0071 | 0.0052 | 0.0018 | 0.0041 |
| 4 w 40° C. | 0.0083 | 0.0003 | 0.0000 | 0.0009 |
| 4 w 50° C. | — | — | 0.0000 | — |

Xiameter® AFE-0100 is a silicone-based antifoaming agent available from Dow Corning Corporation

Kelzan® CC was used as the source of xanthan gum (Kelzan is a registered trademark of and available from CP Kelco).

Proxel® GXL was used as the source of 20% 1,2-benzisothiazolin-3-one (Proxel is a registered trademark of Arch UK Biocides and is available from Lonza).

### Results

Formulation 4 exhibited superior stability to Formulations 2, 3 and 5. Based on these results further formulations similar to Formulation 4 were prepared.

### Example 4—Further Formulation Stability Study

### Methods

The formulation in Table 7, below, was prepared and subjected to 54° C. for 2 weeks, 50° C. for 1 month, 45° C. for 2 months, 40° C. for 4 months and room temperature for 1 year. Following storage at the accelerated storage conditions, the formulation was measured for syneresis, bottom clear time and sprayability. Results of this experiment are shown in Table 8, below.

### Syneresis

Syneresis was determined by placing the composition in a 125-milliliter high density polyethylene (HDPE) bottle at the above-mentioned storage conditions. The height of the top clear liquid phase was then measured. Syneresis is calculated using the following equation: Height of top clear liquid phase/height of total sample.

A high syneresis value indicates poor formulation stability.

TABLE 7

| Formulation 6 | % w/w |
|---|---|
| Ethaboxam (99.3%) | 10.46 |
| Metalaxyl (99.7%) | 5.58 |
| Inpyrfluxam TG (97.56%) | 6.97 |
| Pluronic ® L92 | 5.26 |
| Morwet ® D-425 | 3.00 |
| Atlox ® 4917 | 2.00 |
| Esentia NA-STK-COAT | 10.00 |
| Glycerin | 8.00 |
| Xiameter ® AFE-0100 | 0.05 |
| Proxel ® GXL | 0.40 |
| Kelzan ® CC | 0.30 |
| Water | 47.98 |

TABLE 8

| | Formulation 6 | | | | | | | |
|---|---|---|---|---|---|---|---|---|
| | 54° C. | FT | 50° C. | 45° C. | 45° C. | 40° C. | 40° C. | RT |
| | 2 w | 2 w | 1 m | 1 m | 2 m | 2 m | 4 m | 1 y |
| Syneresis | 53.00% | 3.60% | 0.00% | 5.60% | 4.80% | trace | 4.80% | 21.05% |
| Bottom Clear | >10 min | 1 s | 3 min + | 40 s + | >10 min | 1 s | >10 min | 7 s |
| Time (sec) | | | ring | ring | | | | |
| Sprayability | <0.001% | <0.001% | 0.0000% | 0.0000% | 0.000% | 0.0000% | <0.001% | 0.1065% |
| 100 mesh | | | | | | | | |

### Results

As demonstrated in Table 8, above, Formulation 6 was stable at many accelerated storage conditions but had poor bottom clear time at high temperatures and poor syneresis and sprayability when stored at room temperature for one year. Specifically, a hard caking problem at the high temperature stage and significant crystal growth issues after long time room temperature storage.

### Example 6—Further Formulation Stability Study

### Method

The formulation in Table 9, below, was prepared and subjected to 54° C. for 2 weeks, F/T for 2 months, 50° C. for 2 months, 40° C. for 4 months, −15° C. for 2 months and room temperature for 6 months. Following storage at the accelerated storage conditions, the formulation was measured for syneresis, bottom clear time, sprayability and particle size. Results of this experiment are shown in Table 10, below.

### Physical Stability

Physical stability is determined by particle size. Particle sizes were measured for each composition. D (v, 0.1), D (v, 0.5) and D (v, 0.9) values were measured. D (v, X) denotes the proportion of particles whose diameter measured below the given value in microns.

### Rheology Properties

The rheological properties including viscosity, G′, G″ was measured using Haak Mars Modular Advanced Rheometer System made by Thermo Scientific, model number: MARS 2.

TABLE 9

| Formulation 7 | % w/w |
|---|---|
| Metalaxyl | 5.629 |
| Inpyrfluxam | 7.036 |
| Ethaboxam | 10.554 |
| Pluronic ® L92 | 5.257 |
| Morwet ® D-425 | 3 |
| Atlox ® 4917 | 2 |
| Esentia NA-STK-COAT | 10 |
| Aerosil ® 200 | 0.5 |
| Xiameter ® AFE-0100 | 0.51 |
| Glycerin | 8 |
| Kelzan ® CC | 0.302 |
| Proxel ® GXL | 0.402 |
| Water | 46.81 |

Aerosil® 200 (CAS #112 945-52-5, 7631-86-9) is a hydrophilic fumed silica and is available from Evonik Industries.

TABLE 10

| | Storage Conditions | | | | |
|---|---|---|---|---|---|
| | | 54° C. | F/T | 50° C. | 50° C. |
| | Initial | 2 w | 1 m | 1 m | 2 m |
| Syneresis | 0.075 | 2.74% | 4.88% | 4.48% | 8.70% |
| Bottom Clear | 3 s | 2 s | 3 s | 1 s | 4 s |
| Time | | | | | |
| pH(neat) | 7.14 | 6.94 | 7.09 | 6.92 | 6.81 |
| Sprayability | — | 0.0090% | 0.0020% | 0.0083% | 0.0044% |
| 100 mesh | | | | | |
| Sprayability | — | 0.0113% | 0.0137% | 0.0212% | 0.008% |
| 200 mesh | | | | | |
| Particle size | 0.516 | 0.560 | 0.505 | 0.511 | 0.549 |
| D (v, 0.1) | | | | | |
| Particle size | 1.858 | 1.825 | 1.854 | 1.740 | 1.917 |
| D (v, 0.5) | | | | | |
| Particle size | 5.023 | 4.849 | 16.541 | 4.552 | 4.887 |
| D (v, 0.9) | | | | | |
| Viscosity at | 4971 | 3881 | 4146 | 3791 | 4493 |
| 20° C. 1 sec − 1 | | | | | |
| Viscosity at | 286 | 289.2 | 246.9 | 263.2 | 334.2 |
| 20° C. 50 sec − 1 | | | | | |
| Viscosity at | 97.81 | 107.3 | 75.92 | 106.20 | 130.30 |
| 20° C. G′ | | | | | |
| (t = 0.1 Pa) | | | | | |
| Viscosity at | 43.54 | 52.75 | 37.00 | 50.99 | 61.41 |
| 20° C. G″ | | | | | |
| (t = 0.1 Pa) | | | | | |

| | Storage Conditions | | | | |
|---|---|---|---|---|---|
| | 40° C. | −15° C. | F/T 2 m + | 40° C. | |
| | 2 m | 2 m | RT 1 m | 4 m | RT 6 m |
| Syneresis | 2.78% | — | 17.14% | 11.69% | 16.67% |
| Bottom Clear | 1 s | — | 1~22 s | 10 s | 14 s |
| Time | | | | | |
| pH(neat) | 6.96 | — | 6.89 | 6.84 | 7.11 |
| Sprayability | 0.0054% | 0.0374% | 0.0120% | 0.0044% | 0.0058% |
| 100 mesh | | | | | |
| Sprayability | 0.0117% | 0.0735% | 0.0294% | 0.0123% | 0.0196% |
| 200 mesh | | | | | |
| Particle size | 0.551 | 0.624 | 0.501 | 0.474 | 0.780 |
| D (v, 0.1) | | | | | |
| Particle size | 1.624 | 2.366 | 1.937 | 1.612 | 2.258 |
| D (v, 0.5) | | | | | |
| Particle size | 4.131 | 5.931 | 20.665 | 4.650 | 5.370 |
| D (v, 0.9) | | | | | |
| Viscosity at | 3980 | — | 4391 | 3230 | 3180 |
| 20° C. 1 sec − 1 | | | | | |
| Viscosity at | 247.8 | — | 267.7 | 202.9 | 189.5 |
| 20° C. 50 sec − 1 | | | | | |
| Viscosity at | 95.050 | — | 84.520 | 32.530 | 34.910 |
| 20° C. G′ | | | | | |
| (t = 0.1 Pa) | | | | | |
| Viscosity at | 48.09 | — | 41.65 | 15.95 | 12.82 |
| 20° C. G″ | | | | | |
| (t = 0.1 Pa) | | | | | |

### Results

As exhibited in Table 10, above, the addition of Aerosil® 200 resulted in sufficient bottom clear times, however crystal growth was observed after long term storage.

### Example 7—Further Formulation Stability Study

### Method

The formulation in Table 11, below, was prepared and subjected to 54° C. for 2 weeks, F/T for 2 months, 50° C. for 2 months, 40° C. for 4 months, 4° C. for 4 months, −15° C. for 5 months and room temperature for 6 months. Following storage at the accelerated storage conditions, the formulation was measured for syneresis, bottom clear time, sprayability and particle size. Results of this experiment are shown in Table 12, below.

TABLE 11

| Formulation 8 | % w/w |
|---|---|
| Density | 1.09 |
| Metalaxyl | 2.81 |
| Inpyrfluxam | 3.52 |
| Ethaboxam | 5.28 |
| Pluronic ® L92 | 5.257 |
| Morwet ® D-425 | 4 |
| Atlox ® 4917 | 2 |
| Esentia NA-STK-COAT | 10 |
| Aerosil ® 200 | 0.5 |
| Xiameter ® AFE-0100 | 0.051 |
| Glycerin | 8 |
| Kelzan ® CC | 0.4 |
| Veegum ® R | 0.5 |
| Proxel ® GXL | 0.45 |
| Water | 57.232 |

TABLE 12

| | Storage Conditions | | | | | |
|---|---|---|---|---|---|---|
| | | 54° C. | FT | 50° C. | 50° C. | 40° C. |
| | Initial | 2 w | 1 m | 1 m | 2 m | 2 m |
| Syneresis (%) | — | 0.00% | 0.00% | 6.78% | 1.75% | 0.00% |
| Bottom Clear | — | 30 s | 1 s | 20 s | 30 | 1 s |
| Time (sec) | | | | | s->60 s | |
| pH (neat) | — | 8.33 | 7.62 | 7.32 | 7.14 | 7.36 |
| Sprayability | — | 0.0000% | 0.0000% | 0.0061% | 0.0118% | 0.0000% |
| (%) 100 mesh | | | | | | |
| Sprayability | — | 0.0011% | 0.0000% | 0.0092% | 0.0161% | 0.0021% |
| (%) 200 mesh | | | | | | |
| Particle size D | 0.743 | 1.41 | 0.783 | 1.2 | 1.82 | 0.854 |
| (v, 0.1) | | | | | | |
| Particle size D | 2.49 | 6.55 | 3.71 | 6.66 | 8.86 | 5.26 |
| (v, 0.5) | | | | | | |
| Particle size D | 13.1 | 24.3 | 17.6 | 28.2 | 39.7 | 22.5 |
| (v, 0.9) | | | | | | |

| | Storage Conditions | | | | |
|---|---|---|---|---|---|
| | FT | 40° C. | 4° C. | −15° C. | RT |
| | 2 m | 4 m | 4 m | 5 m | 6 m |
| Syneresis (%) | 3.45% | 5.17% | 14.52% | — | 0.00% |
| Bottom Clear | 10 s | 5 s | 1 s | — | 1 s |
| Time (sec) | | | | | |
| pH (neat) | 7.6 | 7.36 | 7.61 | 7.48 | 7.46 |
| Sprayability | 0.0028% | 0.0024% | 0.0019% | 0.0013% | 0.0010% |
| (%) 100 mesh | | | | | |
| Sprayability | 0.0166% | 0.0047% | 0.0034% | 0.0043% | 0.0044% |
| (%) 200 mesh | | | | | |
| Particle size D | 0.917 | 0.944 | 0.712 | 0.742 | 0.75 |
| (v, 0.1) | | | | | |
| Particle size D | 5.31 | 6.66 | 2.48 | 4.57 | 2.55 |
| (v, 0.5) | | | | | |
| Particle size D | 21.7 | 32.8 | 16 | 142 | 14 |
| (v, 0.9) | | | | | |

Veegum® R is magnesium aluminum silicate (Veegum is a registered trademark of and available from Vanderbilt Minerals, LLC)

### Results

As exhibited in Table 12, above, formulations of the present invention provide sufficiently stable formulations containing metalaxyl and inpyrfluxam without the use of propylene glycol.

### Example 8—Further Formulation Stability Study

### Method

Formulations 9 and 10 in Table 13, below, were prepared and subjected to 54° C. for 2 weeks, F/T for 1 month followed by RT for 1 month, 50° C. for 2 months, 40° C. for 4 months, F/T for 2 months followed by RT for 2 months, and −15° C. for 2 months. Following storage at the accelerated storage conditions, the formulation was measured for syneresis, bottom clear time, sprayability and particle size. Results of this experiment are shown in Tables 14 and 15, below.

TABLE 13

| | Formula- | Formula- | Formula- |
|---|---|---|---|
| | tion 9 | tion 10 | tion 11 |
| Density | 1.09 | 1.09 | 1.09 |
| Metalaxyl | 2.81 | 2.81 | 2.81 |
| Inpyrfluxam | 3.52 | 3.52 | 3.52 |
| Ethaboxam | 5.28 | 5.28 | 5.28 |
| Pluronic ® L92 | 5.257 | 5.257 | 5.52 |
| Morwet ® D-425 | 4 | 4 | 4.2 |
| Atlox ® 4917 | 1 | 1 | 2.1 |
| Tersperse ® 2612 | 2 | 2 | — |
| Agnique ® CP 72L | — | 2 | — |
| Esentia NA-STK-COAT | 10 | 10 | 10.5 |
| Aerosil ® 200 | 0.5 | 1 | 0.5 |
| Xiameter ® AFE-0100 | 0.051 | 0.051 | 0.051 |
| Glycerin | 8 | 8 | 8.4 |
| Kelzan ® CC | 0.4 | 0.4 | 0.35 |
| Veegum ® R | 0.5 | 0.5 | 0.5 |
| Proxel ® GXL | 0.45 | 0.45 | 0.45 |
| Water | Q.S. | Q.S. | Q.S. |

TABLE 14

| | Formulation 9 | | | | | |
|---|---|---|---|---|---|---|
| | | 54° C. | FT 1 m/ | 50° C. | 50° C. | 40° C. |
| | Initial | 2 w | RT 1 m | 1 m | 2 m | 2 m |
| Syneresis (%) | — | 0.00% | 13.89% | 6.67% | 7.14% | 0% |
| Bottom Clear | — | 3 | 5 | 40 | 3 s | 3 s |
| Time (sec) | | | | | | |
| pH (neat) | 7 | 6.88 | 7 | 6.92 | 6.82 | 7.20 |
| Sprayability | 0.0004% | 0.0112% | 0.0111% | 0.0174% | 0.0000% | 0.0000% |
| (%) 100 mesh | | | | | | |
| Sprayability | 0.0008% | 0.0140% | 0.0372% | 0.0516% | 0.0087% | 0.0070% |
| (%) 200 mesh | | | | | | |
| Particle size | 0.668 | 1.24 | 0.764 | 0.948 | 0.988 | 0.91 |
| D (v, 0.1) | | | | | | |
| Particle size | 2.19 | 6.36 | 3.29 | 5.54 | 5.44 | 4.82 |
| D (v, 0.5) | | | | | | |
| Particle size | 12.4 | 24.4 | 17.8 | 22.4 | 20.5 | 18.9 |
| D (v, 0.9) | | | | | | |

| | Storage Conditions | | |
|---|---|---|---|
| | −15° C. | FT 2 m/ | 40° C. |
| | 2 m | RT 2 m | 4 m |
| Syneresis (%) | 0.00% | 16.39% | 0.00% |
| Bottom Clear | 5 | 8 s | 5 s |
| Time (sec) | | | |
| pH (neat) | 7.02 | 6.95 | 6.95 |
| Sprayability | 0.0000% | 0.0000% | 0.0000% |
| (%) 100 mesh | | | |
| Sprayability | 0.0029% | 0.0026% | 0.0060% |
| (%) 200 mesh | | | |
| Particle size D | 0.709 | 0.874 | 0.879 |
| (v, 0.1) | | | |
| Particle size D | 2.44 | 3.810 | 5.06 |
| V, 0.5 | | | |
| Particle size D | 20.2 | 15.475 | 21.6 |
| (v, 0.9) | | | |

TABLE 15

| | Formulation 9 | | | | | |
|---|---|---|---|---|---|---|
| | | 54° C. | FT 1 m/ | 50° C. | 50° C. | 40° C. |
| | Initial | 2 w | RT 1 m | 1 m | 2 m | 2 m |
| Syneresis (%) | — | 26.67% | 35.14% | 30.00% | 25.42% | 32.26% |
| Bottom Clear | — | 2 + min | 15 | 20 | >5 min | 6 |
| Time (sec) | | | | | | |
| pH (neat) | 6.4 | 6.27 | 6.52 | 6.31 | — | — |
| Sprayability | 0.0000% | 0.0022% | 0.0010% | 0.0014% | — | — |
| (%) 100 mesh | | | | | | |
| Sprayability | 0.0004% | 0.0152% | 0.0000% | 0.0000% | — | — |
| (%) 200 mesh | | | | | | |
| Particle size | 0.927 | 1.47 | 1.07 | 1.47 | — | — |
| D (v, 0.1) | | | | | | |
| Particle size | 9.2 | 9.93 | 8.27 | 10.5 | — | — |
| D (v, 0.5) | | | | | | |
| Particle size | 44.6 | 35.4 | 36.3 | 38.4 | — | — |
| D (v, 0.9) | | | | | | |

| | Storage | |
|---|---|---|
| | Conditions | |
| | −15° C. | FT 2 m/ |
| | 2 m | RT 2 m |
| Syneresis (%) | 31.03% | 38.81% |
| Bottom Clear | 5 | 34 s |
| Time (sec) | | |
| pH (neat) | 6.4 | |
| Sprayability | 0.0000% | — |
| (%) 100 mesh | | |
| Sprayability | 0.0008% | 0.0007% |
| (%) 200 mesh | | |
| Particle size D | 0.924 | — |
| (v, 0.1) | | |
| Particle size D | 9.38 | — |
| (v, 0.5) | | |
| Particle size D | 41.4 | — |
| (v, 0.9) | | |

### Results

As exhibited in Tables 14 and 15, above, formulations of the present invention provide sufficiently stable formulations containing metalaxyl and inpyrfluxam without the use of propylene glycol.

What is claimed is:

1. An agricultural formulation comprising inpyrfluxam and metalaxyl, wherein the formulation does not compromise propylene glycol.

2. The agricultural formulation of claim 1, further comprising ethaboxam.

3. A method of protecting plants comprising treating plant propagation material with a fungicidally effective amount of the formulation of claim 1.

4. A method for controlling or preventing pest damage of plants comprising applying to the plant propagation material an effective amount of the formulation of claim 1.

5. An agricultural formulation comprising inpyrfluxam, metalaxyl, and one or more excipients selected from the group consisting of a poly(ethylene oxide)-poly(propylene oxide)-poly(ethylene oxide) block copolymer, modified styrene acrylic copolymer, an acrylic copolymer aqueous emulsion, and a hydrophilic fumed silica.

6. The agricultural formulation of claim 5, further comprising ethaboxam.

7. The agricultural formulation of claim 5, further comprising one or more excipients selected from the group consisting of a xanthan gum, a sodium salt of naphthalene sulfonate condensate, a silicone emulsion, magnesium aluminum silicate and 1,2-benzisothiazolin-3-one.

8. The agricultural formulation of claim 5, further comprising an additional excipient selected from a grafted copolymer, grafted modified styrene-maleic anhydride copolymer monomethyl ether and a mixture thereof.

9. A method of protecting plants comprising treating plant propagation material with a fungicidally effective amount of the product of claim 5.

10. A method for controlling or preventing pest damage of plants comprising applying to the plant propagation material an effective amount of the product of claim 5.

11. An agricultural formulation comprising from about 0.1% to about 15% w/w inpyrfluxam, from about 0.1% to about 15% w/w metalaxyl, from about 0.1% to about 10% w/w of a poly(ethylene oxide)-poly(propylene oxide)-poly(ethylene oxide) block copolymer, from about 0.5% to about 10%/ww modified styrene acrylic copolymer, from about 1% to about 30% w/w of an acrylic copolymer aqueous emulsion, and from about 0.01% to about 5% w/w of a hydrophilic fumed silica, wherein w/w denotes weight by total weight of the formulation.

12. The agricultural formulation of claim 11, wherein inpyrfluxam is at a concentration from about 1% to about 10% w/w, metalaxyl is at a concentration from about 1% to about 10% w/w, the poly(ethylene oxide)-poly(propylene oxide)-poly(ethylene oxide) block copolymer is at a concentration from about 1% to about 10% w/w, modified styrene acrylic copolymer is at a concentration from about 1% to about 5% w/w, the acrylic copolymer aqueous emulsion is at a concentration from about 3% to about 20% w/w and the hydrophobic fumed silica is at a concentration from about 0.01% to about 1% w/w.

13. The agricultural formulation of claim 12, wherein the inpyrfluxam is at a concentration from about 3% to about 4% w/w, metalaxyl is at a concentration from about 2% to about 3% w/w, the poly(ethylene oxide)-poly(propylene oxide)-poly(ethylene oxide) block copolymer is at a concentration from about 5% to about 6% w/w, modified styrene acrylic copolymer is at a concentration from about 1% to about 3% w/w, the acrylic copolymer aqueous emulsion is at a concentration from about 9% to about 11% w/w and the hydrophobic fumed silica is at a concentration from about 0.4% to about 0.6% w/w.

14. The agricultural formulation of claim 11, further comprising from about 0.1% to about 15% w/w ethaboxam.

15. The agricultural formulation of claim 11, further comprising from about 1% to about 20% w/w glycerin, from about 0.01% to about 5% w/w xanthan gum, from about 1% to about 15% w/w of a sodium salt of naphthalene sulfonate condensate, from about 0.001% to about 1% w/w of a silicone emulsion, from about 0.01% to about 5% w/w of magnesium aluminum silicate and from about 0.01% to about 5% w/w of 1,2-benzisothiazolin-3-one.

16. The agricultural formulation of claim 11, wherein glycerin at a concentration from about 1% to about 10% w/w, xanthan gum is at a concentration from about 0.1% to about 1% w/w, the sodium salt of naphthalene sulfonate condensate is at a concentration from about 1% to about 10% w/w, the silicone emulsion is at a concentration from about 0.01% to about 0.5% w/w, magnesium aluminum silicate is at a concentration from about 0.1% to about 2% w/w, and 1,2-benzisothiazolin-3-one is at a concentration from about 0.1% to about 2% w/w.

17. The agricultural formulation of claim 11, wherein glycerin is at concentration from about 7% to about 9% w/w, xanthan gum is at a concentration from about 0.3% to about 0.5% w/w, the sodium salt of naphthalene sulfonate condensate is at a concentration from about 3% to about 5% w/w, the silicone emulsion is at a concentration from about 0.04% to about 0.06% w/w, magnesium aluminum silicate is at a concentration from about 0.4% to about 0.6% w/w, and 1,2-benzisothiazolin-3-one is at a concentration from about 0.4% to about 0.5% w/w.
